(19) United States
(12) Patent Application Publication
(10) Pub. No.: US 2010/0018673 A1
(43) Pub. Date: Jan. 28, 2010

(54) Enclosure type inter-piping fluid thermal energy transfer device

(76) Inventor: Tai-Her Yang, Dzan-Hwa (TW)

Correspondence Address: BACON & THOMAS, PLLC, 625 SLATERS LANE, FOURTH FLOOR, ALEXANDRIA, VA, 22314-1176, US

(21) Appl. No.: 12/219,409

(22) Filed: Jul. 22, 2008

(51) Int. Cl. F28D 15/00; F28F 1/10; F16L 9/00

(52) U.S. Cl. 165/104.19; 165/181; 138/177

(57) ABSTRACT

The present invention discloses that the external thermal conductive casing of the supply water flow piping having at least one fluid inlet and at least one fluid outlet is installed with a hollow enclosing structure, wherein besides that the internal space of the hollow enclosing structure for passing through conducting fluid is made with at least two inlet/outlet ports, the remainder is in a hollow closed structure to enclose the piping casing.

### BACKGROUND OF THE INVENTION

(a) Field of the Invention

The present invention discloses a structure device having separation type thermal energy transfer function between supply water flow and thermal conducting fluid.

(b) Description of the Prior Art

The conventional water supply system usually discharges water flow along with the simultaneous thermal energy release.

### SUMMARY OF THE INVENTION

The present invention comprises a piping for passing through supply water flow and a hollow enclosing structure being installed to piping casing, wherein the hollow enclosing structure has at least two thermal conducting fluid inlet/outlet ports for thermal conducting fluid to flow in or flow out.

### BRIEF DESCRIPTION OF THE DRAWINGS

FIG. 1 is a 3D structural schematic view of the enclosure type inter-piping fluid thermal energy transfer device of the present invention.

FIG. 2 is a cross-sectional view of FIG. 1.

FIG. 3 is a structural schematic view of the present invention showing that the portion of piping casing being enclosed by the hollow enclosing structure in contact with thermal conducting fluid is additionally installed with thermal conducting fin structure.

FIG. 4 is a cross-sectional view of FIG. 3.

FIG. 5 is a schematic view of the embodiment of the present invention showing two pipes being enclosed by the hollow enclosing structure.

FIG. 6 is a cross-sectional view of FIG. 5.

### DESCRIPTION OF MAIN COMPONENT SYMBOLS

100: Piping
101: Fluid inlet
101′: Fluid outlet
102: Hollow enclosing structure
103, 104: Thermal conducting fluid inlet/outlet port
105: Internal space of hollow enclosing structure
106: Thermal conducting fin

### DETAILED DESCRIPTION OF THE PREFERRED EMBODIMENTS

The enclosure type inter-piping fluid thermal energy transfer device of the present invention is that the external of thermal conductive casing of the piping for passing through supply water flow, or liquid or gaseous state fluid with thermal energy is installed with a hollow enclosing structure having at least two thermal conducting fluid inlet/outlet ports, wherein the hollow enclosing structure is for passing through thermal conducting fluid including gas or liquid thereby transferring the thermal energy of utility water flow to the thermal conducting fluid inside the hollow enclosing structure.

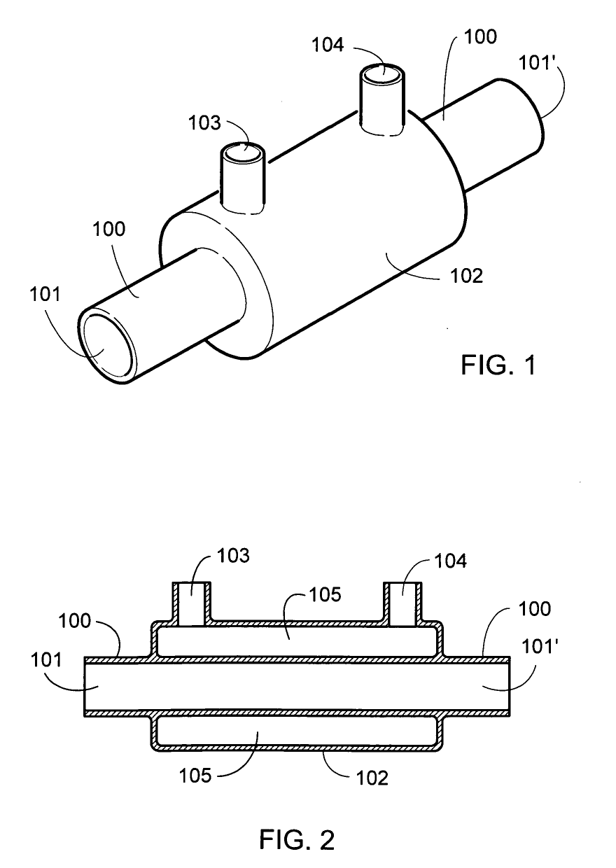

FIG. 1 is a 3D structural schematic view of the enclosure type inter-piping fluid thermal energy transfer device of the present invention. FIG. 2 is a cross-sectional view of FIG. 1. As shown by the structure of the enclosure type inter-piping fluid thermal energy transfer device of the present invention shown in FIGS. 1 & 2, the external of thermal conductive casing of the piping for passing supply water flow, or liquid or gaseous fluid with thermal energy having at least one fluid inlet and at least one fluid outlet is installed with a hollow enclosing structure, wherein besides that the internal space of the hollow enclosing structure for passing through thermal conducting fluid is made with at least two thermal conducting fluid inlet/outlet ports, the remainder is in a hollow closed structure to enclose the piping casing and mainly comprises the following:

The piping (100): It is of the tubular structure having at least one fluid inlet (101) and at least one fluid outlet (101′) for passing through supply water flow, or liquid or gas flow with thermal energy, and having a piping casing being made of thermal conductive material for transferring thermal energy to the thermal conducting fluid inside the hollow enclosing structure (102), wherein the number of enclosed piping (100) can be optionally selected as needed;

The hollow enclosing structure (102): It is used for enclosing the piping casing being made of either thermal conductive or non-conductive material, wherein besides of that the hollow enclosing structure having internal space (105) for passing through thermal conducting fluid is made with at least two thermal conducting fluid inlet/outlet ports, the remainder is in a hollow closed structure to enclose the piping casing, wherein the number of hollow enclosing structures (102) can be optionally selected as needed;

The thermal conducting fluid inlet/outlet ports (103), (104): It is for discharging or receiving thermal conducting fluid and for transferring the thermal energy of thermal conducting fluid inside hollow enclosing structure (102) received from the supply water flow, or liquid or gaseous state fluid inside the piping (100) to the outside target, wherein the number of thermal conducting fluid inlet/outlet ports (103), (104) can be optionally selected as needed;

The internal space (105) of the hollow enclosing structure: It is the space formed between the hollow enclosing structure (102) and the casing of piping (100) for passing through thermal conducting fluid;

In addition, for promoting the performance of transferring the thermal energy of supply water flow, or liquid or gaseous state fluid inside the piping (100) to thermal conducting fluid inside the hollow enclosing structure, the portion of said casing of piping (100) being enclosed by hollow enclosing structure (102) in contact with thermal conducting fluid can be further installed with a thermal conducting fin structure (106) to increase the heat conducting area thereby benefitting the thermal energy transfer to thermal conducting fluid, wherein the interior of hollow enclosing structure (102) can be optionally installed with or not installed with thermal conducting fin structure (106) as needed.

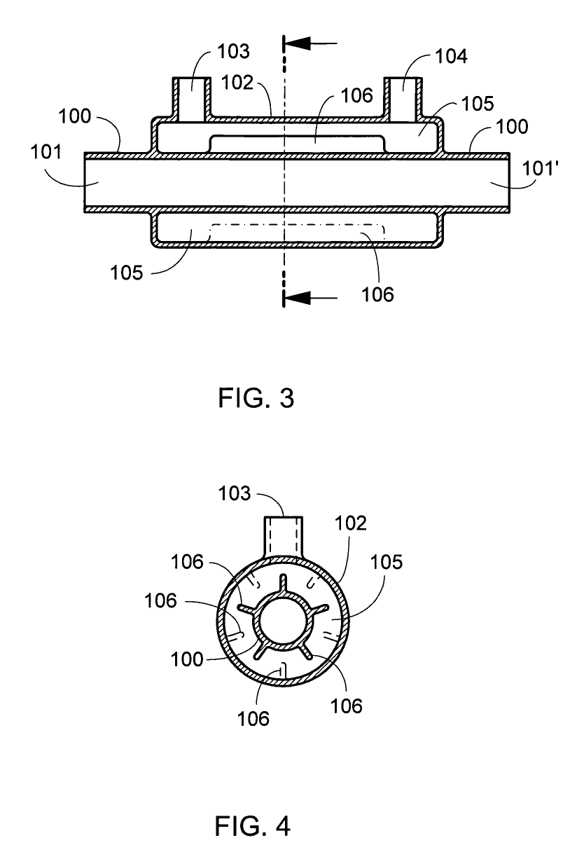

FIG. 3 is a structural schematic view of the present invention showing that the portion of piping casing being enclosed by the hollow enclosing structure in contact with thermal conducting fluid is additionally installed with a thermal conducting fin structure.

FIG. 4 is a cross-sectional view of FIG. 3.

Embodying constitution methods for the enclosure type inter-piping fluid thermal energy transfer device of the present invention include: 1) An integral structure by casting or welding; or 2) a combination structure.

The whole structure or at least the piping structure of said enclosure type inter-piping fluid thermal energy transfer device of the present invention shall be made of material having thermal conductivity such as cast iron, aluminum, copper, stainless steel, or thermal conductive material favorable for thermal energy transfer.

In practical applications of the enclosure type inter-piping fluid thermal energy transfer device of the present invention, the number of enclosed pipes can be one or more than one, and the number of hollow enclosing structures for enclosing pipes can also be one or more than one.

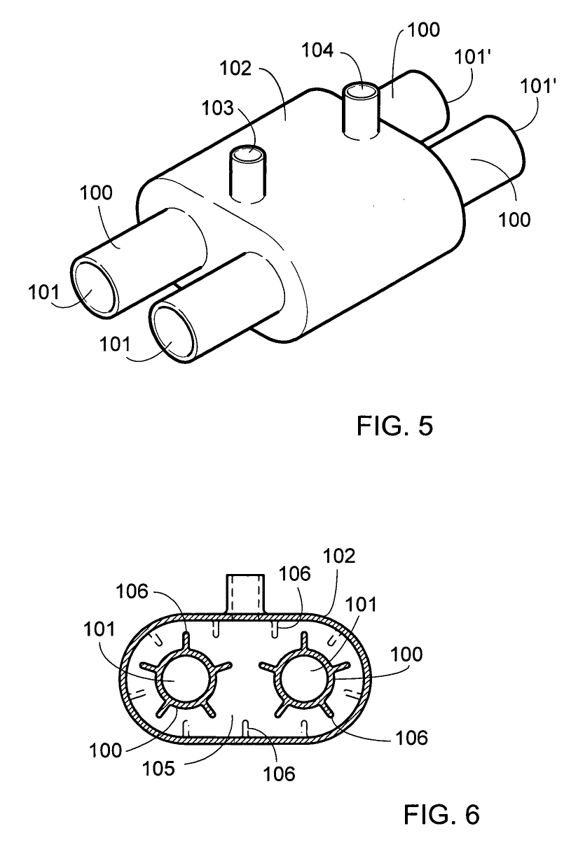

FIG. 5 is a schematic view of the embodiment of the present invention showing two pipes being enclosed by the hollow enclosing structure.

FIG. 6 is a cross-sectional view of FIG. 5.

Beside of the application for thermal energy transfer of the fluid between the piping (100) and the hollow enclosing structure (102), the enclosure type inter-piping fluid thermal energy transfer device of the present invention has the following applications:

1. The application of that the piping (100) is passed through by the gaseous or liquid state fluid with thermal energy for transferring thermal energy to the gaseous or liquid state fluid inside the hollow enclosing structure (102); or

2. The application of that gaseous or liquid state fluid with thermal energy is reversely sent from outside to the hollow enclosing structure (102) via the thermal conducting fluid inlet/outlet ports (103), (104) for transferring thermal energy to gaseous or liquid state fluid inside the piping (100).

1. An enclosure type inter-piping fluid thermal energy transfer device which is installed with a hollow enclosing structure at the external of thermal conductive casing of the piping having at least one fluid inlet and at least one fluid outlet for passing supply water flow, or liquid or gaseous fluid with thermal energy, wherein besides that the internal space of the hollow enclosing structure for passing through thermal conducting fluid is made with at least two thermal conducting fluid inlet/outlet ports, the remainder is in a hollow closed structure to enclose the piping casing and mainly comprises the following:
The piping (100): It is of the tubular structure having at least one fluid inlet (101) and at least one fluid outlet (101′) for passing through supply water flow, or liquid or gas flow with thermal energy, and having a piping casing being made of thermal conductive material for transferring thermal energy to the thermal conducting fluid inside the hollow enclosing structure (102), wherein the number of enclosed piping (100) can be optionally selected as needed;
The hollow enclosing structure (102): It is used for enclosing the piping casing being made of either thermal conductive or non-conductive material, wherein besides of that the hollow enclosing structure having internal space (105) for passing through thermal conducting fluid is made with at least two thermal conducting fluid inlet/outlet ports, the remainder is in a hollow closed structure to enclose the piping casing, wherein the number of hollow enclosing structures (102) can be optionally selected as needed;
The thermal conducting fluid inlet/outlet ports (103), (104): It is for discharging or receiving thermal conducting fluid and for transferring the thermal energy of thermal conducting fluid inside hollow enclosing structure (102) received from the supply water flow or liquid or gaseous state fluid inside the piping (100) to the outside target, wherein the number of thermal conducting fluid inlet/outlet ports (103), (104) can be optionally selected as needed;
The internal space (105) of the hollow enclosing structure: It is the space formed between the hollow enclosing structure (102) and the casing of piping (100) for passing through thermal conducting fluid.

2. The enclosure type inter-piping fluid thermal energy transfer device as claimed in claim 1, wherein for promoting the performance of transferring the thermal energy of supply water flow, or liquid or gaseous state fluid inside the piping (100) to thermal conducting fluid inside the hollow enclosing structure, the portion of said casing of piping (100) being enclosed by hollow enclosing structure (102) in contact with thermal conducting fluid can be further installed with a thermal conducting fin structure (106) to increase the heat conducting area thereby benefitting the thermal energy transfer to thermal conducting fluid, wherein the interior of hollow enclosing structure (102) can be optionally installed with or not installed with thermal conducting fin (106) as needed.

3. The enclosure type inter-piping fluid thermal energy transfer device as claimed in claim 1, wherein embodying constitution methods include an integral structure by casting or welding.

4. The enclosure type inter-piping fluid thermal energy transfer device as claimed in claim 1, wherein embodying constitution methods include a combination structure.

5. The enclosure type inter-piping fluid thermal energy transfer device as claimed in claim 1, wherein the whole structure or at least the piping structure thereof shall be made of material having thermal conductivity such as cast iron, aluminum, copper, stainless steel, or thermal conductive material favorable for thermal energy transfer.

6. The enclosure type inter-piping fluid thermal energy transfer device as claimed in claim 1, wherein in practical applications, the number of enclosed pipes can be one or more than one, and the number of hollow enclosing structures for enclosing pipes can also be one or more than one.

7. The enclosure type inter-piping fluid thermal energy transfer device as claimed in claim 1 includes the application of that the piping (100) is passed through by the gaseous or liquid state fluid with thermal energy for transferring thermal energy to the gaseous or liquid state fluid inside the hollow enclosing structure (102).

8. The enclosure type inter-piping fluid thermal energy transfer device as claimed in claim 1 includes the application of that gaseous or liquid state fluid with thermal energy is reversely sent from outside to the hollow enclosing structure (102) via the thermal conducting fluid inlet and outlet ports (103), (104) for transferring thermal energy to gaseous or liquid state fluid inside the piping (100).
